(19) United States
(12) Patent Application Publication
(10) Pub. No.: US 2016/0196509 A1
(43) Pub. Date: Jul. 7, 2016

(54) TICKET AUTHORISATION

(71) Applicant: MASABI LIMITED, London (GB)

(72) Inventor: Ben Whitaker, London (GB)

(73) Assignee: Masabi LImited, London (GB)

(21) Appl. No.: 14/916,722

(22) PCT Filed: Sep. 5, 2014
(86) PCT No.: PCT/GB2014/052703

§ 371 Date: Mar. 4, 2016

(30) Foreign Application Priority Data
Sep. 5, 2013 (GB) 1315829.0

(51) Int. Cl. G06Q 10/02; G06F 17/30; G06T 1/00

(52) U.S. Cl. CPC G06Q 10/02; G06T 1/0007; G06F 17/30244

(57) ABSTRACT

A method of identifying a valid bearer of a token such as a travel ticket (2) comprises the following steps. First of all, a token issuer (110) receives an image (3) of the valid bearer, and records within or associates with the token a representation (4) of an identifier associated with the image without recording the image on the token. The token issuer (110) communicates with an image recovery service (120) for storage of the image and the associated identifier or transformation of the identifier at the image recovery service. A token examiner (130) obtains the identifier from the token, and uses the image recovery service (120) to obtain the associated image or encrypted image from the identifier or transformation of the identifier. The token examiner may use the associated image to determine that a bearer of the token is the valid bearer. Suitable apparatus is also described, together with specific methods and apparatus for issuing and inspection of tokens and implementation of an image recovery service. In other arrangements, the image is associated with a pre-existing token.

### FIELD OF THE INVENTION

The invention relates to methods, apparatus and systems for ticket authorisation, and in particular to the verification of a ticket owner by a facial image. In particular, the invention relates to the determination by an inspector that a ticket is being presented by the legitimate owner or user of the ticket.

### BACKGROUND OF THE INVENTION

A longstanding problem in ticket authorisation is to ensure that a ticket, or other physical token, is being used by a bearer entitled to use the ticket. The commonest ways to do this are to use either a user signature or a PIN code (so that the bearer can authenticate themselves by demonstrating knowledge of the credential) or by an image of the legitimate owner (so that an inspector can confirm a match between the bearer and the legitimate user). Other authentication approaches are possible (such as use of fingerprints or other biometric information), but these are typically not always practical for ticketing, where low cost and ease of use in a range of different environments are important.

Unfortunately, existing techniques are relatively easy to subvert or create practical difficulties in use. Use of PIN codes is possible where there is an appropriate infrastructure, but if an existing system (such as the banking system) cannot be used for this purpose, the cost of implementation is prohibitive, particularly where it is desirable to have a range of different provision or inspection points. Signatures and user photographs and photo ID cards are vulnerable to forgery or physical subversion of the ticket itself, and checking of signatures or photo-cards by humans is notoriously poor or infrequent. Such physical subversion can be addressed by provision of tickets or photographic identity cards which are tamperproof or hard to copy, but this significantly increases the cost and inconvenience of producing tickets or ID cards.

Some approaches have been proposed to address the effectiveness of use of images with tickets. U.S. Pat. No. 6,971,009 proposes the use of customer provided images for customer printed tickets, which are also provided with a merchant generated security feature indexed by a barcode. The merchant can use the image and, on scanning the barcode, the indexed security features to determine that the bearer of the ticket is the legitimate user. WO 2006/114613 proposes a system in which a ticket purchaser provides his or her image and phone number, and these are stored with a ticket identifier in a central database. A ticket is generated containing the photo image and the ticket identifier as a barcode. Inspection of the ticket allows comparison of the photo image with the stored image, retrieved by the inspector by scanning of the barcode, however this relies on being able to print the photo image on the ticket.

These existing approaches are unsatisfactory and have not been widely implemented. Implementation costs are significant, and other practical issues, such as privacy, are not effectively addressed. A particularly challenging environment is ticketing for a transportation system, such as a rail network. Where tickets are provided in large numbers and for one use only, it is important that the cost of production is very low and often the ticket printers are not of a suitable quality to reproduce photographic images. It is also important that travel tickets can be inspected effectively at different points in the network, including at times where network connectivity may be limited or non-existent, and that during inspection there is not an extra delay when asking for the customer to retrieve their photo ID for inspection.

It would therefore be desirable to provide a low cost system and method for inspection and (in particular) production of tickets, especially where the system and method are suitable for use in a transportation system.

### SUMMARY OF THE INVENTION

In a first aspect, the invention provides a method of identifying an entitlement associated with a token, comprising: an entitlement issuer receiving an image of a valid bearer of the token, and associating with the token an entitlement and an identifier associated with the image without recording the image on the token; the entitlement issuer communicating with an image recovery service for storage of the image and the associated identifier at the image recovery service; and a token examiner obtaining the identifier from the token, and using the image recovery service to obtain the associated image from the identifier, whereby the token examiner may use the associated image to determine that a bearer of the token is the valid bearer of the token and has the entitlement associated with the token.

This approach is highly advantageous, as it allows image identification of a valid bearer of the token (and hence of the entitlement) at low cost and in a secure manner.

In one arrangement the entitlement issuer is also a token issuer for the token. In alternative arrangements, the token may be a pre-existing token, such as a credit card.

The identifier may be recorded on the token as comprised within a glyph or barcode, for example within a 2D barcode.

The entitlement may be an entitlement to a service, such as an entitlement to travel on a transport service. This entitlement may be provided as a physical ticket, with the identifier is recorded on the token as a printed image or part of a printed image. Alternatively, the token may be provided as electronic data.

Preferably, the image is encrypted using the identifier and the image recovery service provides an encrypted version of the image to the token examiner, and wherein the token examiner uses the identifier to decrypt the encrypted version of the image. In different arrangements, the image may be encrypted by the image recovery service or by the entitlement issuer. Preferably, the image recovery service provides a mathematical transformation of the identifier to the token examiner, and the encrypted version of the image is stored under the mathematical transformation of the identifier.

In a second aspect, the invention provides a method of issuing an entitlement associated with a token such that the token is adapted to identify a valid bearer, the method comprising: receiving an image of the valid bearer, and associating with the token the entitlement and an identifier associated with the image on the token without recording the image on the token; and providing the image and the associated identifier to an image recovery service.

Preferably, the method further comprises issuing the token.

In this method, receiving an image may comprise capturing an image of the valid bearer or may comprise receiving an image comprises receiving an image from the valid bearer or a third party.

The identifier may be recorded on the token as comprised within a glyph or barcode, for example within a 2D barcode.

The entitlement may be an entitlement to a service, such as an entitlement to travel on a transport service. This entitlement may be provided as a physical ticket, with the identifier is recorded on the token as a printed image or part of a printed image.

In a third aspect, the invention provides a method of inspecting a token to determine whether a bearer of the token is the valid bearer of the token, wherein the token comprises an identifier but does not comprise an image of the valid bearer, the method comprising: obtaining the identifier from the token; obtaining an image associated with the identifier from an image recovery service; and using the associated image to determine that a bearer of the token is the valid bearer.

Preferably, this method comprises receiving an encrypted image from the image recovery service, and decrypting the encrypted image with the identifier. In a preferred arrangement, the encrypted image is stored under a mathematical transformation (such as a hash) of the identifier, and further comprising mathematically transforming the identifier to identify the encrypted image.

The step of obtaining an image associated with the identifier from an image recovery service may comprise preloading a database of images with associated identifiers from an image recovery service.

The method may also comprise obtaining a further image of the valid bearer and in providing said further image to the image recovery service.

Preferably, the image recovery service is provided by a server remote from inspection of the token.

In a fourth aspect, the invention provides a ticket comprising a printed representation of an identifier, wherein the identifier is associated with an image of a valid bearer of the ticket, and wherein the image of the valid bearer of the ticket is not printed on the ticket.

In one arrangement, the identifier is recorded on the ticket as comprised within a glyph or barcode, such as a 2D barcode. In another arrangement, the identifier is recorded on the ticket as comprised within a wireless token.

The ticket may be a transportation ticket.

In a fifth aspect, the invention provides token issuing apparatus for issuing a token such that the token is adapted to identify a valid bearer, the apparatus comprising: means for receiving an image of the valid bearer, and means for recording an identifier associated with the image on the token without recording the image on the token; and means for ensuring that the image and the associated identifier are stored in an image recovery service.

The means for receiving the image of the valid bearer may comprise a camera for capturing a digital image of the valid bearer.

The means for providing the image and the associated identifier to an image recovery service may comprise a network connection to a remote computer hosting the image recovery service.

The token issuing apparatus may comprise computing apparatus associated with a purchaser of the token in communication with a token provider, such as a mobile telecommunications terminal.

In some such arrangements, the token may be provided as electronic data.

In other arrangements, the token issuing apparatus is a ticket machine. This may comprise point of sale computing apparatus.

The means for recording an identifier may comprise a printer to provide a printed ticket comprising a representation of the identifier. The representation of the identifier may be comprised within a glyph or a barcode, such as a 2D barcode.

In a sixth aspect, the invention provides token inspection apparatus to determine whether a bearer of a token is the valid bearer of the token, wherein the token comprises an identifier but does not comprise an image of the valid bearer, the apparatus comprising: means to obtain the identifier from the token; means to obtain an image associated with the identifier from an image recovery service; and means to enable determination from the associated image that a bearer of the token is the valid bearer.

The means to obtain the identifier from the token may comprise a scanner to scan a representation of the identifier, and the means to obtain the identifier may further comprise a processor programmed to determine the identifier from the scanned representation.

In embodiments, the token inspection apparatus is associated with an automated gate. In other embodiments, the token inspection apparatus is associated with point of sale apparatus. In further embodiments, the token inspection apparatus is a portable computing apparatus adapted to be carried by a ticket inspector.

The means to obtain an image associated with the identifier may comprise a network connection to remote computing apparatus hosting the image recovery service. The means to obtain an image associated with the identifier may comprise a database preloaded to the ticket inspection apparatus comprising images of valid ticket bearers indexed by identifiers for the valid ticket bearers. Preferably, the preloaded database does not contain any further credentials to identify valid ticket bearers.

The means to obtain an image associated with the identifier may comprise one or more encrypted images obtained from the image recovery service. Preferably, each encrypted image is stored under a mathematical transformation, such as a hash, of the associated identifier.

In embodiments, the means to enable determination from the associated image that a bearer of the token is the valid bearer comprises a display to display the image of the valid bearer associated with the identifier to an inspector. In some embodiments, the ticket inspection apparatus comprises a camera adapted to take a further image of the bearer of the token. In this case, the means to enable determination from the associated image that a bearer of the token is the valid bearer comprises a processor programmed with image recognition software to compare a further image of the bearer of the token taken with the camera with the image associated with the identifier, and to determine whether the bearer of the token is the valid bearer of the token from this comparison. Determination whether the bearer of the token is the valid bearer of the token comprises determining to what degree of certainty the bearer matches. The token inspection apparatus may be adapted to provide a further image of the bearer of the token to the image recovery service.

In a seventh aspect, the invention provides an image recovery service comprising computing apparatus and a database, wherein the computing apparatus is adapted to receive and store in the database, for a token to be provided to a valid bearer, an identifier and at least one image of the valid bearer associated with the valid bearer, and wherein the computing apparatus is adapted on receipt of a valid query to provide the at least one image associated with one or more identifiers.

Preferably, each image is encrypted with its associated identifier. In such a case, on receipt of a valid query, the image recovery service provides each relevant encrypted image under a mathematical transformation, such as a hash, of its associated identifier. The image recovery service may be adapted to provide a subset of the database to a valid inspector for use in identification of valid bearers. Preferably, the image recovery service is adapted only to provide identifiers and images associated with those identifiers to inspectors from the database, and is not adapted to provide any further credential associated with valid bearers of tokens.

### BRIEF DESCRIPTION OF DRAWINGS

Specific embodiments of the invention will be described below, by way of example, with reference to the accompanying drawings, of which:

FIG. 1 shows the different elements of a system in which embodiments of the invention may be implemented;

FIGS. 2a to 2d show different embodiments of a system for providing a ticket according to an embodiment of one aspect of the invention;

FIG. 3 illustrates schematically a method of providing a ticket according to an embodiment of one aspect of the invention;

FIG. 4 shows an example of a ticket produced with the embodiment of FIG. 2;

FIG. 5 shows a system for inspecting a ticket according to an embodiment of a further aspect of the invention;

FIG. 6 illustrates schematically a method of inspecting a ticket according to an embodiment of the further aspect of the invention; and

FIG. 7 illustrates schematically a ticketing system (in the specific embodiment illustrated, a transportation system) indicating ticket purchase and inspection points of different types.

### DESCRIPTION OF SPECIFIC EMBODIMENTS

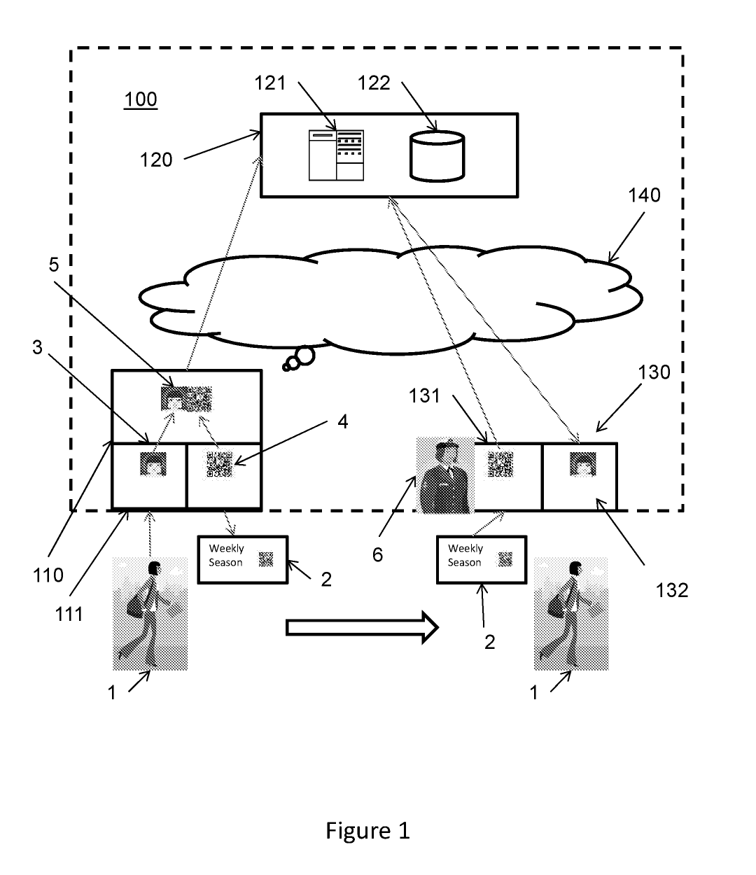

FIG. 1 shows the different elements of a system 100 in which embodiments of the invention may be implemented. Interacting with the ticketing and inspection system 100 is a valid bearer 1 of a ticket 2. Ticketing and inspection system 100 is in the case illustrated a ticketing system for a transportation system (such as a train network), but it could equally be any other kind of ticketing system where tickets should or may be associated with specific bearers, such as tickets to an entertainment event.

The bearer 1 of the valid token is shown interacting with the ticketing and inspection system 100 at two points. The first point of interaction is at a token issuer, shown here as token issuing apparatus 110. In this case, the token issuing apparatus is shown as an automatic ticket machine, but as discussed below, other forms of token issuing apparatus may be used in different embodiments of the invention. The token issuer receives an image of the valid bearer 1—in the case shown, this is by capturing an image 3 of the valid bearer 1 with a camera apparatus 111. An identifier is associated with this image 3—this may be a number or other variable, but is given a visible representation, such as 2D bar code 4. This 2D bar code 4, but not the image 3, is printed on to the token—in this case, ticket 2.

The image identifier pair 5 is then provided to an image recovery service 120, generally over an appropriate networking structure such as the public internet 140. The image recovery service 120 comprises a remote server 121 (or a similar computing system) and a memory 122 storing an image and identifier database.

The other point at which the token bearer interacts with the ticketing and inspection system is on inspection. Token inspection apparatus 130 may be incorporated within different apparatus—in this case, it is shown as a portable device for use by a ticket inspector 6. The portable device contains scanning apparatus 131 to scan the 2D bar code 4 on the ticket 2 to recover the identifier. The identifier is then sent to the image recovery service 120, which returns the associated image 3. This may require an appropriate authentication step to ensure that the query has been made by someone authorised to make it, such as a valid ticket inspector 6 or by apparatus under their control. In this case, the returned image 3 is displayed on a display 132 of the token inspection apparatus, so that the ticket inspector 6 may make a visual comparison between the image 3 and the appearance of the ticket bearer 1, and may thereby reach a decision on whether the ticket bearer 1 is the valid bearer.

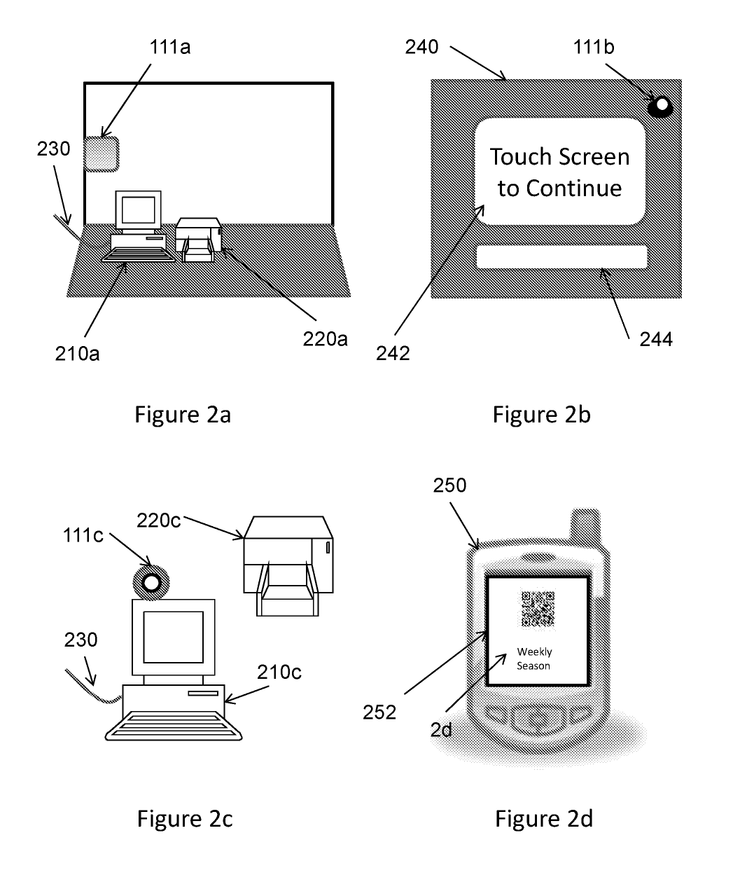

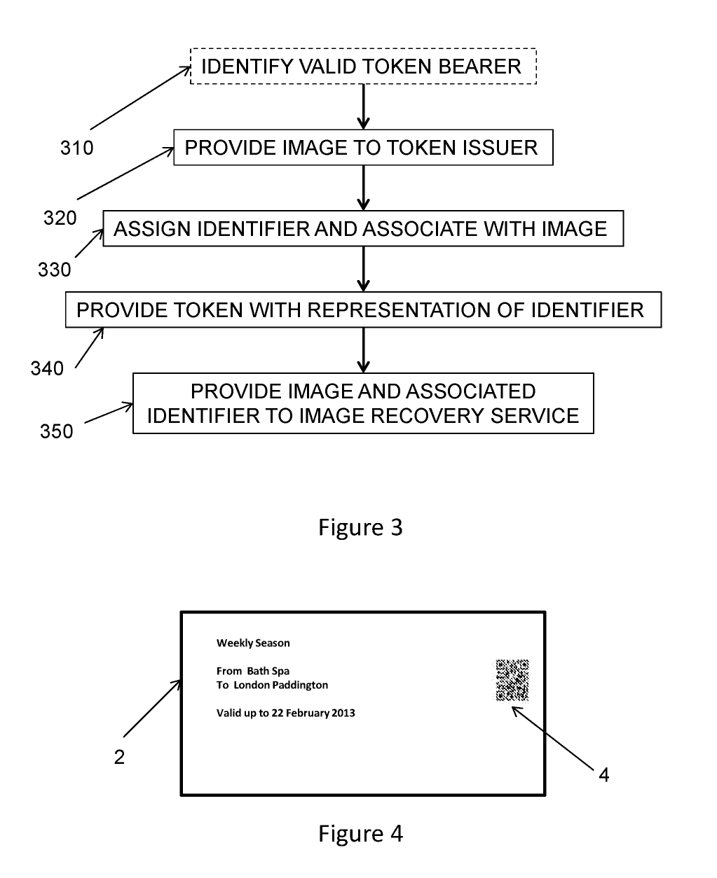

Different embodiments of token issuing apparatus and methods will now be described with reference to FIGS. 2a to 2d and 3. FIGS. 2a to 2d show alternative embodiments of a token issuing apparatus, whereas FIG. 3 illustrates schematically method steps in issuing a token.

While the apparatus for implementing a method of issuing a token, such as a travel ticket, according to embodiments of the invention may vary, the steps indicated in FIG. 3 are generally employed. If not already evident (for example, from the purchase process), the valid token bearer is identified (step 310, shown as optional). An image of the valid token bearer—typically a normal facial image, such as a passport photograph—is then provided (step 320) to the token issuer. As can be seen from the embodiments described, this image may be captured by the token issuer or provided by or on behalf of the valid token bearer.

An identifier is then assigned (step 330) to the valid token bearer and associated with the received image. A token is then provided (step 340) by the token issuer including a representation of the identifier, but without the received image. The token may in embodiments be provided as a printed ticket, or as electronic data. The identifier and associated image are then provided (step 350) to an image recovery service—typically hosted on a remote server, as shown in FIG. 1.

The generation of the identifier and its provision to the valid token bearer may be achieved in a number of different ways. The identifier may simply be a number used to identify the ticket or user generally, or may be a specific identifier generated for use in the image recovery service. The identifier may also be generated locally, or generated centrally by the image recovery service. The identifier provided on the token may also be a modified, encrypted or obfuscated version of the originally generated number—for example, an encrypted or hashed version of the true identifier.

Four different implementations of token issuing apparatus are shown in FIG. 2: FIG. 2a shows an implementation for a manned ticket counter; FIG. 2b shows an implementation for an automatic ticket machine; FIG. 2c shows an implementation for a purchaser's home computer; and FIG. 2d shows an implementation for a purchaser's mobile telephone. As is discussed below, these different forms of token issuing apparatus may all be adapted to implement the method steps shown in FIG. 3, but with some differences in the approach taken to implementation to best suit the different use contexts.

In the FIG. 2a arrangement, the token issuing apparatus is under the control of the token issuer, and can readily be integrated with the apparatus used to provide tokens such as travel tickets at the point of sale. In FIG. 2a, the ticket issuing apparatus 110 comprises the issuer POS “Point of Sale” computer 210a, a camera 111a controlled from the issuer

POS computer 210a, a ticket printer 220a also controlled from the issuer POS computer 210a, and a network connection 230 to a remote server hosting the image recovery service. The issuer POS computer runs a program to implement relevant method steps. This may be stored in memory of the issuer POS computer, or the issuer POS computer may act as a client to a remote server performing some of the method steps. For example, generation of the identifier and corresponding 2D barcode may be done by the image recovery service, rather than by the issuer POS computer. The token issuing steps of embodiments of the invention may be built into the normal ticket selling and issuing routines used by the issuer, and may for example be triggered when a particular ticket type requiring additional security is sold. For example, purchase of a season ticket may require these additional steps to enhance security, whereas the purchase of a single journey ticket may not require such steps.

As the process is under control of an issuer operative, all information is captured directly by the issuer and is under issuer control. The issuer operative should be able to take necessary steps to ensure success of the procedure, such as ensuring that the photograph is a satisfactory representation of the valid token bearer. Typically, the issuer operative would simply use camera 111a—probably installed at a fixed location—to capture images of the valid token bearer (generally the purchaser) until a satisfactory image was achieved. The ticket 2 may be printed using without any modification to an existing printer 220a, as the only change made is to ticket format to include the 2D barcode providing the representation of the image identifier. The identifier and image pair are provided to the image recovery service (though as stated previously, if the issuer POS computer acts as a client to the remote server hosting the image recovery service during the token issuing process, the identifier information at least may originate at the image recovery service).

It can be seen that the changes required to a conventional ticket issuing apparatus used by, for example, a train network are minor. A camera 111a is required as a peripheral to the issuer POS computer 210a, and there will be some addition to ticket purchase and/or issue software, but there are no other significant changes required at the point of sale. In particular, there is no increase in the cost of providing the ticket itself—this is in marked contrast to the provision of a conventional photocard (which involves significantly greater cost—to the issuer, to the customer, or to both, than a ticket) or to the provision of a ticket with an embedded photographic credential, which is inherently more expensive to produce. In both these conventional cases, there is a significant additional cost required to protect the photographic credential against forgery or other subversion. In the case of the ticket produced by embodiments of the invention, there is simply additional printing on the existing ticket, with no additional security requirements and no added costs.

FIG. 2b shows an alternative point of sale implementation, this time by means of an automated ticket machine 230. This is essentially similar to the approach of FIG. 2a in that the apparatus is under control of the token issuer, but differs in that the user interface 232 is under the control of the ticket purchaser (assumed for the purposes of this discussion also to be the valid token bearer). The method steps discussed in FIG. 3 may be combined with an existing ticket purchase process at the automated ticket machine 240, or with an existing ticket collection process for a ticket purchased remotely (for example on the purchaser's own PC through an online ordering process). The automated ticket machine will be programmed to guide the purchaser through the interaction with the machine necessary to produce the ticket. As before, no change is required to the ticket printing process of a conventional automated ticket machine—tickets will be printed in a conventional manner in the printing apparatus terminating in slot 244—but there will be some change required to incorporate capture of a user image. Essentially, this involves no more than incorporation of the functionality of a basic automated photo booth into the ticket machine—camera 111b is located or in connection with the machine, the user is guided through a process of positioning to enable an effective image to be captured, image capture and display (on the user interface 242—shown here as a touchscreen—or another dedicated photo display), with confirmation if the image is acceptable and provision for retaking if it is not. The decision as to whether the image is acceptable may be left to the user, or may be under full or partial control of software adapted to analyse the image and reject it if certain criteria are not met (such as correct location of the head and visibility of user features). As before, the automated ticket machine 240 interacts with the image recovery service to ensure that the image recovery service has the appropriate image and identifier pair.

The steps carried out by the issuer operative may, in principle, be carried out by a customer on their own home computer, as is shown in FIG. 2c. The bearer's own personal computer 210c may be used in generating the identifier and in communicating with the image recovery service over a network connection 230—in this case, the bearer's personal computer 210c will preferably act as a client with a remote server generating the identifier and the representation for printing on the ticket—in fact, the entire image for printing on the ticket may generally be generated remotely and communicated back to the bearer's personal computer, as this minimises exposure of sensitive code and provides the greatest security. Additional security measures may even be employed (such as a registration and authentication process) to establish the credentials of the user—in practice, this is likely to be integrated with a ticket purchase process in which such credentials are already used. A webcam 111c integrated with, or used as a peripheral to, the bearer's personal computer 210c can be used to capture an image of the bearer, or an existing image may simply be submitted from memory on the bearer's computer 210c or from a reference to an image held on a remote system such as an existing photo ID service from employer or another organisation, a photo sharing service, or social media site (in principle, this approach could be taken for other embodiments as well). The ticket may then be printed on the bearer's own personal printer 220c—this approach is frequently adopted for online purchase of train and aeroplane tickets, and can apply just as well to embodiments of the present invention, as the only difference in the printing step is the addition of a specific additional 2D barcode.

It is also possible for the ticket 2d to be delivered to a mobile telephone 252, as is shown in FIG. 2d. The ticket 2d may be provided as electronic data which can be displayed for inspection on the screen 252 providing the user interface of a mobile telephone 252. Alternatively, the electronic data may be arranged to be subsequently read or interrogated through one or more of the following means: contact, wirelessly, magnetically, optically, or via an acoustic/audio signal. The mobile telephone 252 may also perform the same role as the bearer's personal computer 210c in FIG. 2c, enabling the bearer to cooperate with a remote server to establish an identifier and to provide an image to the image recovery service by an appropriate network (either a data network, cellular telecommunications network allowing provision of data, a remote image, or images and text, or a local wireless network, in this case). Again, this may be a pre-existing stored image or an image captured by a camera (not shown) integrated within the mobile telephone 252.

A combination of these approaches may also be used—for example, a bearer's personal computer may be used to purchase a ticket and establish an identifier and image pair, but the ticket itself may be delivered to the bearer's mobile telephone or may be required to be collected from an automated ticket machine.

An example of a ticket 2 produced by the methods and apparatus discussed above is shown in FIG. 4. The only difference between this ticket and a conventional ticket is the presence of an image identifier barcode 4 (a 2D barcode is shown as this is a particularly effective and robust way to encode data on to a printed ticket, but other kinds of barcode or glyph could also be used). The barcode may not simply be for image identification—where desired, in embodiments it may carry other reference numbers or ticket details. Apart from the supporting infrastructure, which is also relatively inexpensive as it mainly uses resources that will exist in a purchasing system, transport system or home environment, the marginal cost of producing a ticket is minimal as no physical security is required in the ticket 2 itself. The ticket itself also provides no direct visual indication of the security feature—the appearance of the valid bearer—that has been added to protect it.

It should be noted that other ticket types may be used in embodiments of the invention. While a 2D barcode is a particularly effective way to store the representation of the identifier, it may be simply printed as a number, provided as text which can be read by an OCR system, stored on a magnetic track, or even stored within a contactless smartcard or tag. For a ticket retained on a mobile phone, the identifier may be implemented with an appropriate wireless technology and it may be made available on several different formats simultaneously.

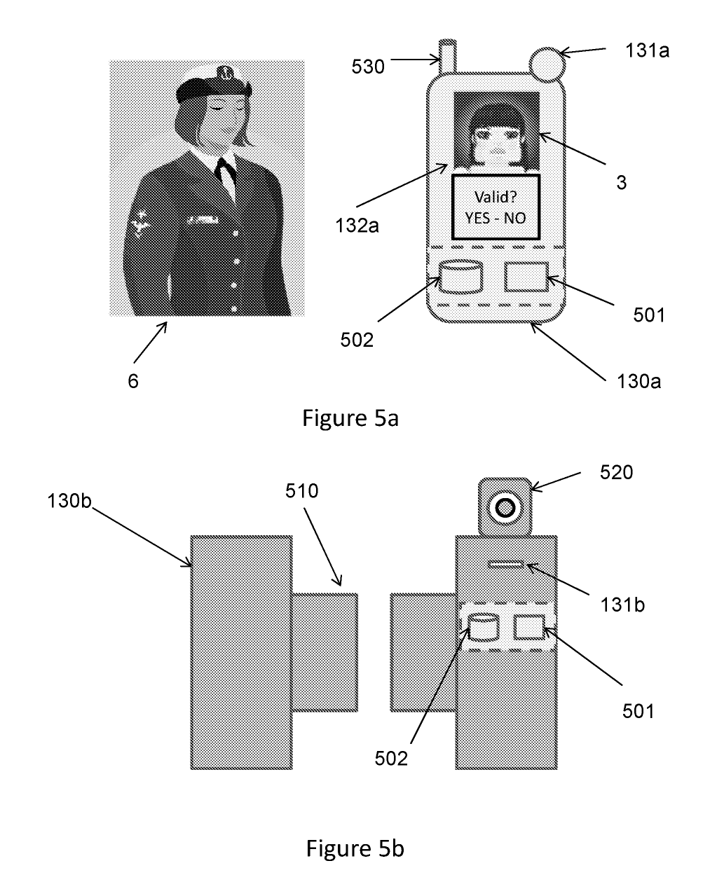

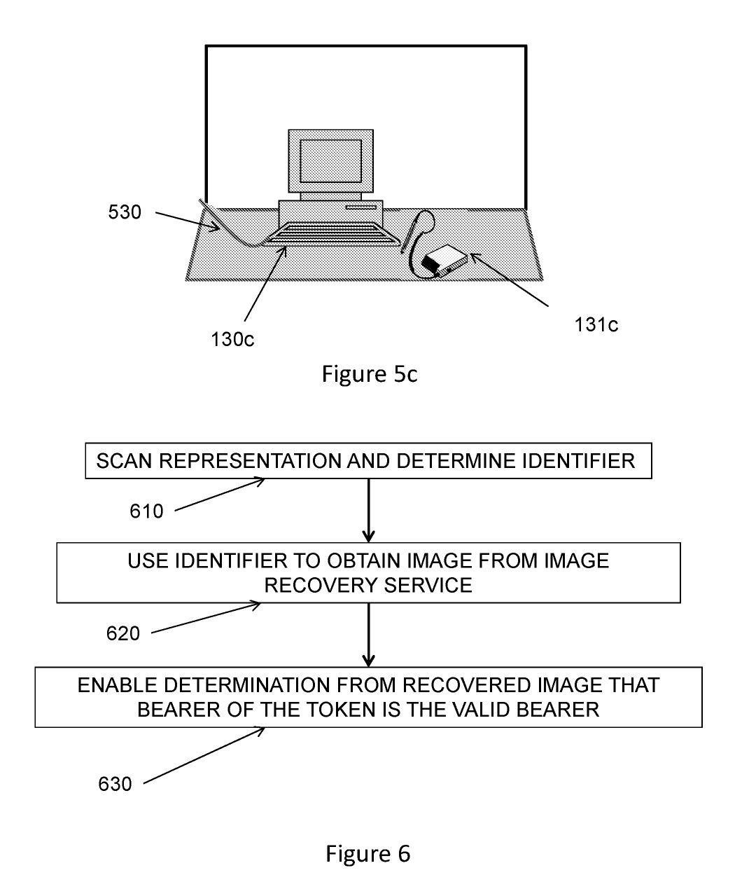

Different embodiments of token inspection apparatus and methods will now be described with reference to FIGS. 5a to 5c and 6. FIGS. 5a to 5c show alternative embodiments of a token inspection apparatus, whereas FIG. 6 illustrates schematically method steps in inspecting a token.

As set out in FIG. 6, the first step to be carried out is to scan (step 610) the ticket and to determine the identifier from scanning its representation on the ticket. The identifier is then used (step 620) to obtain the corresponding image from the image recovery service. From the corresponding image and from the appearance of the bearer, it can then be determined (step 630) whether the bearer of the ticket is indeed the valid bearer. Three different implementations of ticket inspection apparatus using this approach are shown in FIGS. 5a, 5b and 5c.

FIG. 5a shows a mobile ticket inspection apparatus as might be used by a ticket inspector operating on a transportation system (for example, on a train). While shown here as a discrete piece of apparatus, this could be integrated with any other device used by such a ticket inspector, such as a portable point of sale machine to enable tickets to be sold on the train. The apparatus 130a is shown here with the form factor of a mobile telephone (though other form factors are possible), with a processor 501 and a memory 502 shown schematically, and a camera 131a to capture a 2D barcode and a display 132a to display the image 3 to the ticket inspector 5 and to provide a user interface for the ticket inspection routine run by the processor 501 using the memory 502 (each represented as a single element for convenience, though in practice multiple processors and/or memories may be used).

The apparatus 130a is shown with an antenna 530 to make a network connection with the image recovery service (or any other remote server required by the process). However, for mobile inspection of tickets, it may not be possible to guarantee that a network connection will be available throughout the ticket inspection process—for example, a train may lose access to cellular telephony networks when in a tunnel. This can be addressed by preloading data that may be needed by a ticket inspector to the memory 502 of the apparatus 130a, either by making a network connection at an earlier point or perhaps simply by provision of the data on or via a physical medium. As the apparatus 130a is under control of the ticket inspector, the risk of subversion is low. There may be privacy concerns about disseminating sensitive customer data—these may be minimised by providing only image and identifier pairs in the preloading process, and not providing any other customer credentials—this should prevent identification of any customer from the data alone and should avoid any intercepted data from being used from any unwanted purpose. It should be relatively straightforward to determine which identifiers an inspector may need to review (for example, all season tickets which may cover a particular route and which are note out of date), and for the relevant identifier and image pairs to be extracted from the main image recovery service database and preloaded to the ticket inspection apparatus 130a.

Security may be enhanced yet further if images are only provided by the image recovery service in an encrypted form. The images may be encrypted on storage by the image recovery service under an appropriate key recoverable from the identifier. The images themselves may be provided to the ticket inspection apparatus in encrypted form and without a corresponding identifier—preferably, the ticket inspection device will be provided with a hash of the identifier, so that the ticket inspection device can determine that the identifier is valid but will not have the identifier itself, with the encrypted image stored under the hashed identifier. The recovered identifier is then used to decrypt the image so that the decrypted image is shown to the ticket inspector 6. In this way, images are prevented from unauthorised access by anyone that does not know the identifier, making subversion even more difficult. This is discussed further below with reference to the operation of the image recovery service.

If apparatus 130a is designed to operate without any network connection, the software to control the scanning of the 2D barcode, the determination of the identifier and the presentation of the image associated with the identifier must all run on processor 501 using code stored in memory 502. Each of these functions can be carried out by software or under software control in a conventional manner.

A further possibility with this arrangement is updating of the valid bearer image. If the ticket inspector is satisfied that there is a match between the valid bearer and the image recovered from the image recovery service, but considers that the recovered image is not satisfactory (for example, if the bearer has changed appearance significantly), then the ticket inspector may use camera 131a to capture a further image and submit it (either immediately or later, if more efficient to do so) to the image recovery service. This may replace the original image, or there may simply be multiple images stored with for a given identifier. If there are multiple images, an appropriate strategy may be used when recovery is required (for example, all the images may be returned, or only the most recent image unless further images are requested).

FIG. 5b shows an alternative implementation in a ticket controlled gate of a transportation network. The apparatus 130b comprises a gate part 510 which is activated when a valid ticket is inserted into a scanning interface, represented here by scanning slot 131b. Ticket elements may be scanned using whatever scanning technology is appropriate to the ticket (magnetic stripe, RFID, barcode) and in addition a camera or barcode scanner is included to capture the representation of the identifier. A relevant computing system (shown here as processor 501 and memory 502 illustrated as lying within the gate, but in practice likely to be located remotely from the gate but in contact with relevant elements of the gate through a local network) recovers the identifier and obtains the image from the image recovery service, either dynamically through a network connection (not shown) or by a preloading mechanism as previously described. In the arrangement shown, a camera 520 also captures an image of the ticket bearer and the relevant computing system carries out an image matching process (for which conventional facial matching techniques may be used) to determine whether there is a satisfactory match between the two. If not, then appropriate action may be taken (the gate does not operate, the gate operates but warns a local inspector, the gate operates but a warning flag is logged against the identifier record on the image recovery service, or similar). Alternatively, no camera may be used but the image from the image recovery service may simply be displayed to an operative manning the gate, so that clear mismatches between image and bearer may be questioned.

FIG. 5c shows an alternative arrangement for inspection at a point of sale terminal—this may be appropriate for admission to an event or an attraction, where tickets may be bought directly or existing tickets checked. In this case, the main apparatus element is the point of sale computer 130c, connected to the image recovery service by a network connection 530, with a scanner camera 131c used to capture the 2D barcode from the ticket. The process of validation can operate essentially as for the ticket inspector apparatus 130a described in FIG. 5a, though there will be no obvious need for preloading in this environment. It will be appreciated that instead of the dedicated scanner camera 131c, a 2D barcode could be captured in essentially the same arrangement as for ticket issuing, as shown in FIG. 2a. The FIG. 2a and the FIG. 5c arrangements may be readily combined into one, using common hardware.

As previously indicated, the image recovery service 120 is advantageously hosted on a remote server 121 and comprises a database stored in a memory 122 (while the server 121 and memory 122 are shown as single elements, they may of course be comprised of a number of separate elements, possibly physically separated but connected by a network). The image recovery service 120 needs to be secured against subversion, as it contains sensitive customer data—it may also be used for generation of identifiers and associated representations, particularly where the ticket issuing apparatus cannot be assumed to be secure (as in the case of customer computers).

The image recovery service may also provide encryption or hashing of identifiers for provision on the ticket. As is discussed above, the images themselves may also be encrypted and in some arrangements only provided by the image recovery service 120 in encrypted form. It is desirable to ensure that the identifiers under which the images are stored are sufficiently random and form a sufficiently large set that they will be effective to provide encryption keys. The process of storage may then involve hashing the identifier and using that as an identifier to be downloaded to remote validation devices, and encryption of the image with the identifier before storing it for transmission to the remote validation devices. Other forms of encryption or mathematical transformation may be used rather than hashing where use of hashing is described in relation to embodiments of the invention—however in the discussion below only reference to hashing will be made for convenience. In this way only the encrypted image and the hashed identifier are provided to the remote validation device, with the image only accessible when the identifier is provided by the ticket. Retrieval of the photograph then comprises taking the identifier from the ticket, hashing it, retrieving the encrypted image stored with the index corresponding to the hashed identifier, and decrypting the image with the original identifier.

For greater security, encryption may be used for the index under which images are stored as well as for the images themselves. For example, each encrypted image may be stored under an index which is a hash of the identifier, and encrypted using the identifier. Alternatively, each encrypted image may be stored under an index which is a transformation of the identifier and encrypted under a different transformation of the identifier.

In an alternative arrangement, image encryption may also take place at the point of sale. This would prevent the image recovery service from seeing or transmitting or storing the images in an unencrypted form. This could have benefits in meeting privacy goals—for example, the ticket issuer and image recovery service may then run in an manner isolated from each other so as to make it impossible for employees from one part of the system to access images only available in the other unless they have an additional permission—allowing it to be necessary for a court order to be obtained for a party with access only to encrypted images to view images, for example, rather than this being possible simply by having sufficient privilege on a relevant computing system.

Further details may be stored by the image recovery system, though not communicated to ticket inspection apparatus—these may determine whether and when the image should be updated, whether the image can be retrieved without the ticket present, or determination of which images should be provided to which inspection devices. The individual functions described for the image recovery service may be implemented by the person skilled in the art using conventional security and database management techniques.

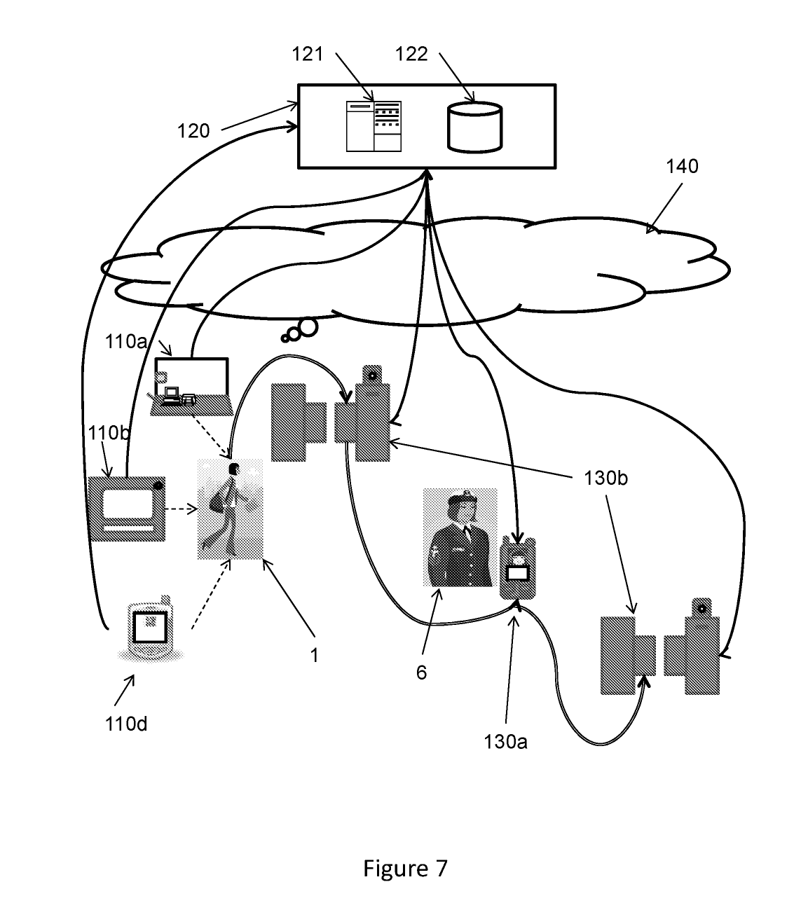

FIG. 7 shows an exemplary transportation system and illustrates a typical customer journey using the approaches described above. A traveller 1 purchases a ticket from an available outlet such as ticket desk 110a, automated ticket machine 110b or smartphone 110d—in each case the identifier and associated image are stored in the database 122 of the image recovery service 120 under the control of the image recovery service remote computer 121, and the traveller is established as the valid bearer of the ticket. The traveller then enters the transportation system through a first automated ticket gate 130b, where the identifier is checked to ensure that the stored image matches that of the traveller. This may be implemented as a lower level security check (for example, in which an action is triggered only if there is a clear mismatch, or where image matching is only intermittently in operation) to allow high passenger throughput. A higher level security check may be carried out in the transportation system by a ticket inspector 6 using appropriate ticket inspection apparatus 130a. The traveller 1 may then leave the transportation system through a second automated ticket gate 130b. The ticket inspection apparatus 130a and the automated ticket gates 130b are both in communication with the image recovery service 120, either dynamically or at an earlier time during which appropriate image and identifier records have been downloaded locally. This implementation of a ticket validation system provides significantly enhanced validation without significant infrastructural cost while preserving customer privacy.

While discussion above has been made primarily in the context of a transportation system, aspects of the invention are equally applicable to other contexts in which it is desirable to ensure the valid bearer of a token. Embodiments may for example be used for admission to sporting or entertainment events, or to establish the valid bearer of a valuable credential such as a bank card, or to allow entry to a place of work or other secured facility, or to allow entry to a club etc, or to provide authentication for voting.

In further embodiments, the issuer need not be a token issuer, but only the issuer of an entitlement which is then associated with an existing token, such as a membership card, a credit card or other bank card, a passport, a biometric identifier, or wireless ID device etc. The image may then be stored against an identifier provided in or derived from that existing token so that a new token need not be issued in order to prove the bearer is entitled to travel.

1-70. (canceled)

71. A method of issuing an entitlement associated with a token such that the token is adapted to identify a valid bearer, the method comprising:
receiving an image of the valid bearer, and associating with the token the entitlement and an identifier associated with the image on the token without recording the image on the token; and
providing the image and the associated identifier to an image recovery service.

72. A method as claimed in claim 71, further comprising issuing the token.

73. A method as claimed in claim 71, wherein receiving an image comprises capturing an image of the valid bearer.

74. A method as claimed in claim 71, wherein the entitlement is an entitlement to travel on a transport service.

75. A method as claimed in claim 71, wherein the token is provided as electronic data.

76. A method as claimed in claim 75, wherein the token is provided as electronic data that can be held on a portable device or media, and subsequently read or interrogated through one or more of the following means: contact, wirelessly, magnetically, optically, or via an acoustic/audio signal.

77. A method as claimed in claim 71, wherein the image is encrypted using the identifier and the image recovery service provides an encrypted version of the image to the token examiner, and wherein the token examiner uses the identifier to decrypt the encrypted version of the image.

78. Token inspection apparatus to determine whether a bearer of a token is the valid bearer of the token, wherein the token comprises an identifier but does not comprise an image of the valid bearer, the apparatus comprising:
an information capture apparatus to obtain the identifier from the token;
a processor programmed with instructions for:
obtaining an image associated with the identifier from an image recovery service; and
enabling determination from the associated image that a bearer of the token is the valid bearer.

79. Token inspection apparatus as claimed in claim 78, wherein the token inspection apparatus is associated with either an automated gate or a point of sale apparatus.

80. Token inspection apparatus as claimed in claim 78, wherein in order to obtain an image associated with the identifier, the token inspection apparatus further comprises a network connection to remote computing apparatus hosting the image recovery service.

81. Token inspection apparatus as claimed in claim 78, wherein in order to obtain an image associated with the identifier, the token inspection apparatus further comprises a database preloaded to the ticket inspection apparatus comprising images of valid ticket bearers indexed by identifiers for the valid ticket bearers, wherein the preloaded database does not contain any further credentials to identify valid ticket bearers.

82. Token inspection apparatus as claimed in claim 78, wherein in order to obtain an image associated with the identifier, the token inspection apparatus further comprises one or more encrypted images obtained from the image recovery service.

83. Token inspection apparatus as claimed in claim 82, wherein any one of the following:
(a) each encrypted image is stored encrypted under an encryption utilizing a mathematical transformation of the associated identifier; or
(b) each encrypted image is stored under an index which is a mathematical transformation of the identifier, and encrypted using the identifier; or
(c) each encrypted image is stored under an index which is a transformation of the identifier and encrypted under a different transformation of the identifier.

84. Token inspection apparatus as claimed in claim 78, wherein in order to enable determination from the associated image that a bearer of the token is a valid bearer, the token inspection apparatus further comprises a display to display the image of the valid bearer associated with the identifier to an inspector.

85. Token inspection apparatus as claimed in claim 78, wherein the ticket inspection apparatus comprises a camera adapted to take a further image of the bearer of the token, and wherein in order to enable determination from the associated image that a bearer of the token is a valid bearer, the token inspection apparatus further comprises a processor programmed with image recognition software to compare a further image of the bearer of the token taken with the camera with the image associated with the identifier, and to determine whether the bearer of the token is the valid bearer of the token from this comparison.

86. An image recovery service comprising computing apparatus and a database, wherein the computing apparatus is adapted to receive and store in the database, for a token to be provided to a valid bearer, an identifier and at least one image of the valid bearer associated with the valid bearer, and wherein the computing apparatus is adapted on receipt of a valid query to provide the at least one image associated with one or more identifiers.

87. An image recovery service as claimed in claim 86, wherein each image is encrypted with its associated identifier.

88. An image recovery service as claimed in claim 87, wherein on receipt of a valid query, the image recovery service provides each relevant encrypted image under a mathematical transformation of its associated identifier.

89. An image recovery service as claimed in claim 86, wherein the image recovery service is adapted to provide a subset of the database to a valid inspector for use in identification of valid bearers.

90. An image recovery service as claimed in claim 86, wherein the image recovery service is adapted only to provide identifiers and images associated with those identifiers to inspectors from the database, and is not adapted to provide any further credential associated with valid bearers of tokens.
